(19) United States
(12) Patent Application Publication
(10) Pub. No.: US 2025/0363279 A1
(43) Pub. Date: Nov. 27, 2025

(54) LOCAL CLOCK BUFFER WITH ANTENNA DIODE FEATURE

(71) Applicant: International Business Machines Corporation, Armonk, NY (US)

(72) Inventors: Rajesh VEERABHADRAIAH, Tumkur (IN); Vishal SINDHE, Bangalore (IN); Meenakshi SHARMA, Bangalore (IN); Amit Bipinbhai PATEL, Bengaluru (IN); Ananth Nag Raja DARLA, Bangalore (IN); Krishnan MOHAN, Bangalore (IN)

(21) Appl. No.: 18/672,625

(22) Filed: May 23, 2024

(51) Int. Cl. G06F 30/367; G06F 30/39; G06F 115/02; G06F 117/10; G06F 119/02; H04B 17/17; H04B 17/29

(52) U.S. Cl. CPC G06F 30/367; G06F 30/39; H04B 17/17; H04B 17/295; G06F 2115/02; G06F 2117/10; G06F 2119/02

(57) ABSTRACT

Techniques relating to identifying an antenna violation for a first local clock buffer (LCB) for an integrated circuit (IC). The IC includes a first LCB block containing the first LCB and a first antenna diode disconnected from the first LCB, and a second LCB block containing a second LCB and a second antenna diode, different from the first antenna diode, disconnected from the second LCB. The techniques include determining, based on the identifying the antenna violation, to connect the first antenna diode to the first LCB, and connecting the first antenna diode to the first LCB in the first LCB block. The second antenna diode remains disconnected from the second LCB after the connecting.

### BACKGROUND

The present invention relates to semiconductor fabrication, and more specifically, to integrated circuit (IC) fabrication.

### SUMMARY

Embodiments include a method. The method includes identifying an antenna violation relating to a first local clock buffer (LCB) for an integrated circuit (IC). The IC includes a first LCB block containing the first LCB and a first antenna diode disconnected from the first LCB, and a second LCB block containing a second LCB and a second antenna diode, different from the first antenna diode, disconnected from the second LCB. The method further includes determining, based on the identifying the antenna violation, to connect the first antenna diode to the first LCB, and connecting the first antenna diode to the first LCB in the first LCB block. The second antenna diode remains disconnected from the second LCB after the connecting.

Embodiments further include an integrated circuit (IC), including a first local clock buffer (LCB) block. The first LCB block includes a first LCB for clocking the IC, a first antenna diode, and a connection between the first LCB and the first antenna diode. The connection between the first LCB and the first antenna diode is configured to alleviate an antenna violation for the IC relating to the first LCB. The IC further includes a second LCB block, the second LCB block including second LCB for clocking the IC and a second antenna diode, different from the first antenna diode. The second antenna diode is disconnected from the second LCB.

Embodiments further include a method of manufacturing an integrated circuit (IC). The method includes adding a first local clock buffer (LCB) block to the IC, the first LCB block containing a first LCB and a first antenna diode that is disconnected from the first LCB. The method further includes adding a second LCB block to the IC, the second LCB block containing a second LCB and a second antenna diode, different from the first antenna diode, that is disconnected from the second LCB. The method further includes identifying an antenna violation relating to the first LCB, determining, based on the identifying the antenna violation, to connect the first antenna diode to the first LCB, and connecting the first antenna diode to the first LCB in the first LCB block. The second antenna diode remains disconnected from the second LCB after the connecting.

### BRIEF DESCRIPTION OF THE DRAWINGS

FIG. 1 illustrates an example of transistor fabrication, according to one embodiment.

FIG. 2 illustrates fabrication of an antenna diode for a transistor, according to one embodiment.

FIG. 3 illustrates use of an antenna diode for a local clock buffer (LCB), according to one embodiment.

FIG. 4 illustrates an antenna diode in an LCB block, according to one embodiment.

FIG. 5 illustrates antenna diodes in multiple LCB blocks, according to one embodiment.

FIG. 6 further illustrates an antenna diode in an LCB block, according to one embodiment.

FIG. 7 is a flowchart illustrating connecting an antenna diode to an LCB block, according to one embodiment.

### DETAILED DESCRIPTION

Gate oxide is among the most sensitive components in a metal-oxide-semiconductor (MOS) transistor (e.g., a MOS Field Effect Transistor (MOSFET)). During construction of an integrated circuit (IC), for example an application-specific integrated circuit (ASIC), made up of MOS transistors, special care is taken to safeguard the gate oxide from damage, both throughout the fabrication process and during the functioning of the IC. For example, if a conducting material or wire is erroneously linked to the MOS transistor's gate, the wire acts as an antenna, inducing a considerable amount of charge. Further, diodes produced by drain and source diffusion layers can conduct a significant amount of current. This antenna effect can cause gate failure or deterioration of I-V performance.

For example, in an embodiment an antenna violation occurs when the antenna ratio exceeds a value specified in a Process Design Kit (PDK). The antenna ratio is the ratio of the metal area to the gate area. Antenna violations can be addressed, in some circumstances, by inserting an antenna diode. Inserting an antenna diode typically involves connecting reverse biased diodes near an MOS transistor gate input when a violation (e.g., an antenna violation) occurs. This diode connection gives a discharge channel to the substrate, saving the transistor's gate. The addition of an antenna diode, however, increases the area as well as the capacitance of the component, resulting in a delay increase.

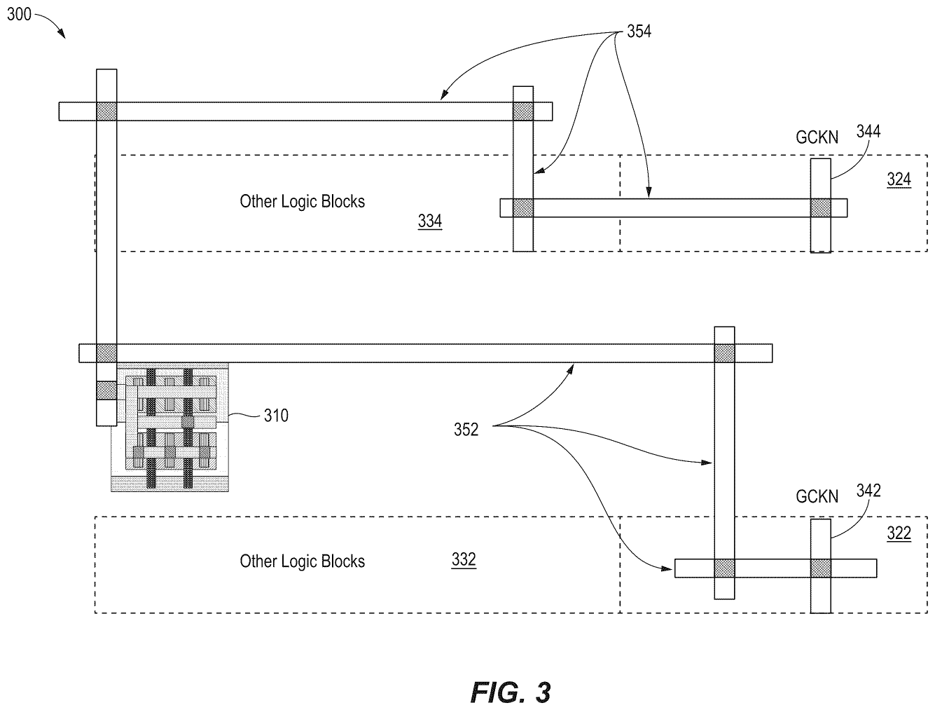

In an embodiment, a local clock buffer (LCB) used for clocking an IC can be prone to antenna violations stemming from gate oxide issues. In an embodiment, an antenna violation for one or more LCBs can be addressed by placing an antenna diode outside the LCB block, and routing the antenna diode to each LCB that has an antenna violation. This is discussed further, below, with regard to FIG. 3. But this requires a diode that is external to the LCB block, and a relatively long connection (e.g., a metal wire) from an LCB pin to the antenna diode, resulting in metal congestion and undesired capacitance from the long connection wire.

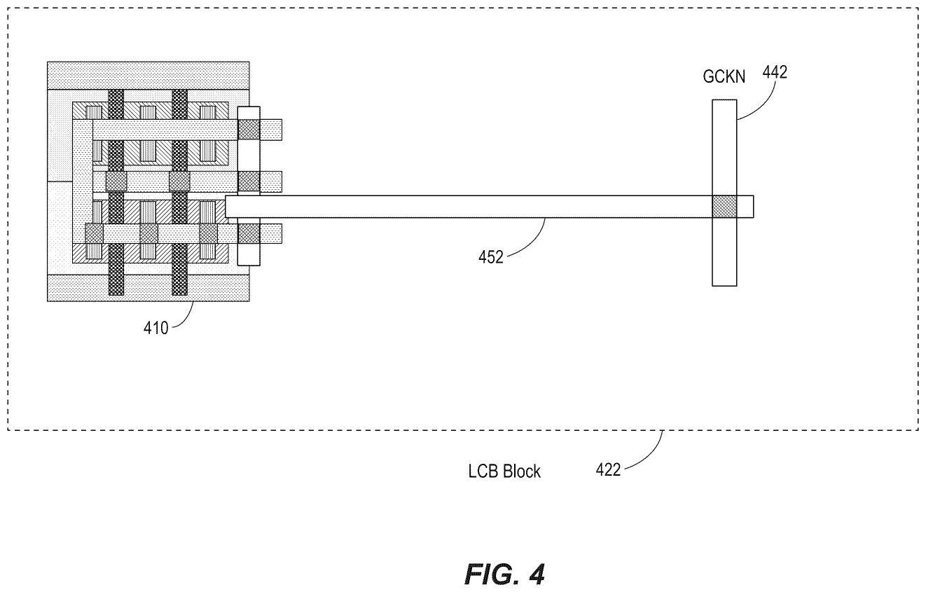

Alternatively, or in addition, antenna violations for LCBs can be address by placing an antenna diode inside each LCB block. The antenna diode can be placed in the LCB block, but only connected to an LCB pin (e.g., to a general clock signal (GCKN) pin) when an antenna violation occurs. This is discussed further, below, with regard to FIGS. 4-7.

Since the antenna diode is located inside the LCB block and located closer to the LCB pin (e.g., as compared to use of an external antenna diode outside the LCB block), much less metal is needed for the connection. This results in reduced routing congestion and avoids undesired capacitance from the connection wire (e.g., because the wire is significantly shorter since the antenna diode is located in the LCB block). Further, where an antenna diode in an LCB block is unused (e.g., because there is not antenna violation), the antenna diode can be used to alleviate signal antenna issues.

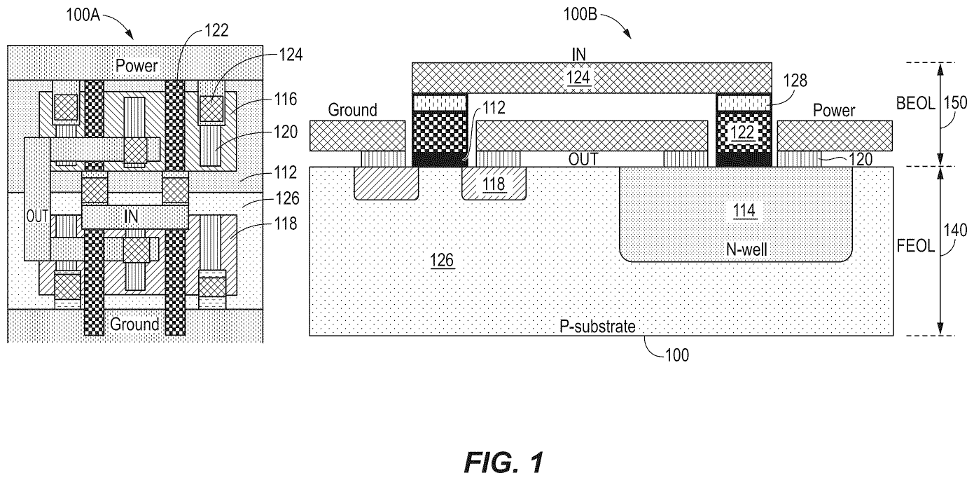

FIG. 1 illustrates an example of transistor fabrication, according to one embodiment. FIG. 1 illustrates an overhead view 100A, and a profile view 100B, of a MOSFET 100. In an embodiment, the MOSFET 100 is fabricated using an oxide layer 112 (e.g., a gate oxide layer). As discussed above, the oxide layer 112 can be particularly sensitive, and damage to the oxide layer 112 can result in antenna violations and other errors.

In an embodiment, the MOSFET 100 further includes an N-well 114, a P+ region 116 (e.g., located inside the N-well 114), a P-substrate 126, and an N+ region 118 (e.g., located inside the P-substrate 126). Further, the MOSFET 100 includes a metal connect or via 120, a poly connect (PC) region 122, a metal region 124, and a PC connect or via 128. In an embodiment, a region 140 of the MOSFET 100 is fabricated in the front of line (FEOL) while a region 150 is fabricated in the back end of line (BEOL). As discussed above, however, the oxide layer 112 is prone to damage that can result in antenna violations. These can be addressed through use of an antenna diode, as discussed further below with regard to FIGS. 3-7.

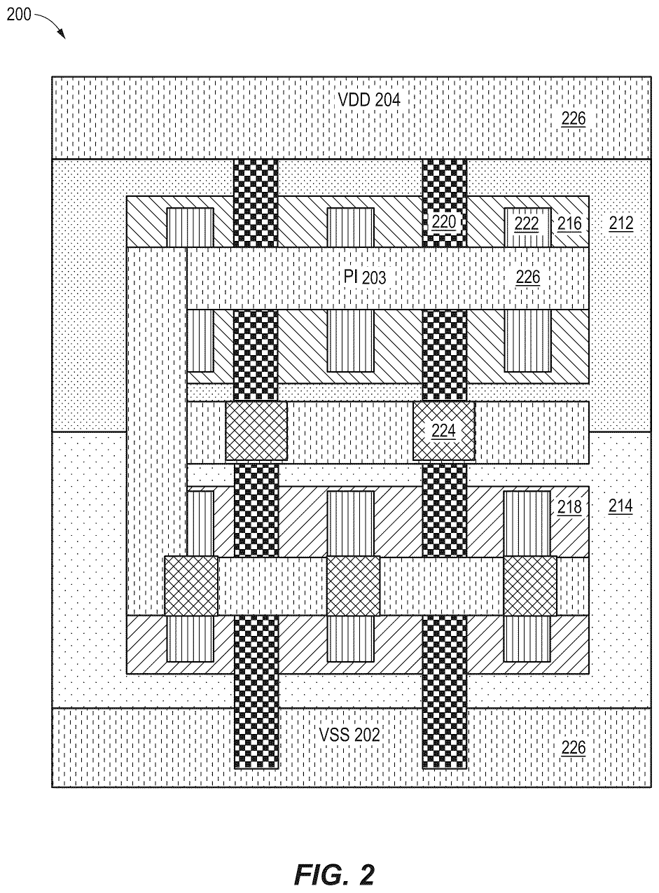

FIG. 2 illustrates fabrication of an antenna diode for a transistor, according to one embodiment. In an embodiment, an antenna diode 200 includes a source (VSS) 202 and a drain (VDD) 204. The antenna diode 200 is made up of an N-well 212, a P-substrate 214, a number of P+ regions 216, and N+ regions 218. Further, the antenna diode includes a number of polysilicon regions 220, diffusion contacts 222, metal contacts 224, and metal 226.

In an embodiment, an antenna diode is formed by connecting the VSS 202, and VDD 204, to the same terminal of a MOSFET (e.g., an NFET). In this example, the source and drain of the NFET forms a diode with the p-substrate 214. The antenna diode 200 further includes a primary input (PI) 203.

FIG. 3 illustrates use of an antenna diode for an LCB, according to one embodiment. In an embodiment, an IC 300 includes an antenna diode 310 used to alleviate antenna violations for LCBs 322 and 324. The antenna diode 310 is located external to the LCBs 322 and 324. In an embodiment, the antenna diode 310 is connected to a pin for each of the LCBs 322 and 324. For example, the antenna diode 310 is connected to the GCKN 342 for the LCB 322 using one or more connections (e.g., metal wires) 352.

As another example, the antenna diode 310 is connected to the GCKN 344 for the LCB 324 using one or more connections (e.g., metal wires) 354. In an embodiment, the antenna diode 310 is placed at a top level in the circuit (e.g., in a location with sufficient space) and connected to LCBs with an antenna violation. Further, as illustrated, the LCBs 322 and 324 can be associated with other logic blocks 332 and 334. In an embodiment, the antenna diode 310 can be located external to these other logic blocks 332 and 334.

As discussed above, connecting the antenna diode 310 to the LCBs 322 and 324 (e.g., via the GCKNs 342 and 344) can address antenna violations. But this requires an external diode 310, located outside the LCBs 322 and 324, and relatively long connection 352 and 354 (e.g., metal wires) from an LCB pin to the antenna diode. This results in unwanted capacitance, an area penalty for antenna diode cells, and metal congestion, among other undesirable effects.

FIG. 4 illustrates an antenna diode in an LCB block, according to one embodiment. In an embodiment, an antenna diode 410 is placed inside an LCB block 422. This differs from the configuration in FIG. 3, where the antenna diode is placed external to the LCB blocks and shared by multiple LCB blocks. The antenna diode 410 is located inside the LCB block 422. When an antenna violation occurs, the antenna diode 410 can be connected to a pin for the LCB. For example, an antenna pin can be connected to a GCKN 442 using a connection 452 (e.g., a wire). This can be done through manual routing, or any other suitable technique.

In an embodiment, the connection 452 is shorter than the connections 352 and 354 illustrated in FIG. 3. This allows for much less metal to be used in the connection. Further, it reduces routing congestion and avoids undesired capacitance from the connection wire.

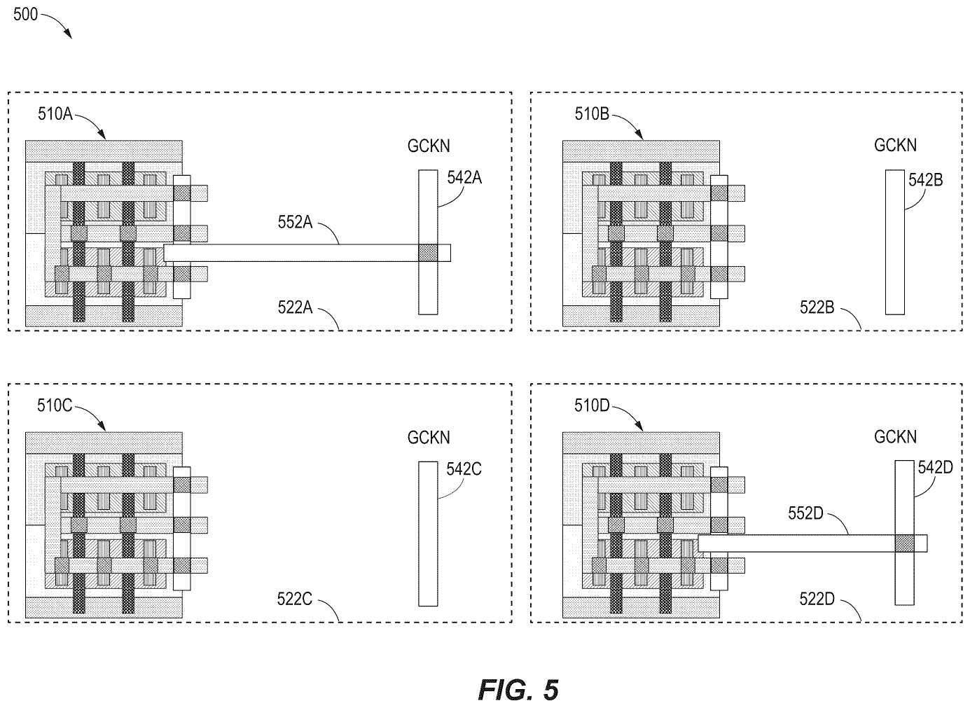

FIG. 5 illustrates antenna diodes in multiple LCB blocks, according to one embodiment. In an embodiment, an IC 500 (e.g., an ASIC) includes multiple LCB blocks 522A, 522B, 522C, and 522D. Each of these LCB blocks 522A, 522B, 522C, and 522D includes a corresponding antenna diode 510A, 510B, 510C, or 510D.

In an embodiment, where an LCB block has an antenna violation, an LCB pin can be connected to a co-located antenna diode to alleviate the violation. For example, assume the LCB block 522A has an antenna violation. A GCKN pin 542A can be connected to the antenna diode 510A. For example, a router (or other suitable tool) can be used to short a pin on the antenna diode 510A to the GCKN 542A (e.g., using a connection 552A).

Similarly, assume the LCB block 522D also has an antenna violation. A GCKN pin 542D can be connected to another antenna diode 510D, located in the LCB block 522D. For example, a router (or other suitable tool) can be used to short a pin on the antenna diode 510D to the GCKN 542D (e.g., using a connection 552D).

By contrast, assume, in an embodiment, that the LCB blocks 522B and 522C do not have antenna violations. These LCB blocks 522B and 522C contain respective antenna diodes 510B and 510C, but the antenna diodes are not connected to the respective GCKN pins 542B and 542C. In an embodiment the antenna diodes are not connected to the respective GCKN pins, because there is no antenna violation.

In an embodiment, where an antenna diode is not connected to an LCB pin to alleviate an antenna violation (e.g., for LCB blocks 522B and 522C illustrated in FIG. 5), the antenna diode can be used to correct signal antenna errors. For example, aspects of an IC may have signal antenna issues. The antenna diodes 510B and 510C are not connected to respective GCKN pins 542B and 542C, and so the antenna diodes 510B and 510C can be used to correct these signal antenna issues. In an embodiment, clock errors (e.g., antenna violations) take priority and are cured first (e.g., by connecting a respective antenna diode to the LCB pin), and then remaining unused antenna diodes can be used to correct signal antenna issues. For example, in one embodiment unused antenna diodes can be connected to ground. Alternatively, or in addition, unused antenna diodes can be connected to a signal antenna (e.g., a nearby signal antenna).

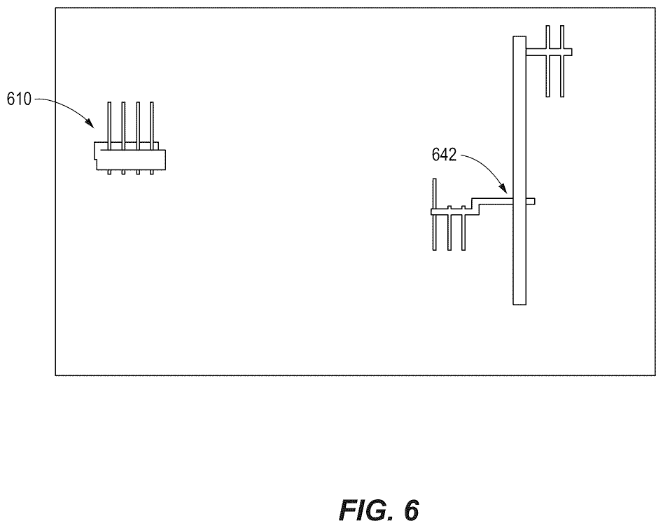

FIG. 6 further illustrates an antenna diode in an LCB block, according to one embodiment. In an embodiment, a layout 600 illustrates an antenna diode 610 located in an LCB block with a GCKN pin 642. As discussed above in relation to FIGS. 4-5, where the LCB experiences an antenna violation, the antenna diode 610 can be connected to the GCKN pin 642 (e.g., a router or other suitable tool can be used to short a pin on the antenna diode 610 to the GCKN pin 642). Where the LCB does not have an antenna violation, the antenna diode 610 can be left unconnected from the LCB, and the antenna diode can be used for another suitable purpose (e.g., to alleviate a signal antenna issue, as discussed above in relation to FIG. 5).

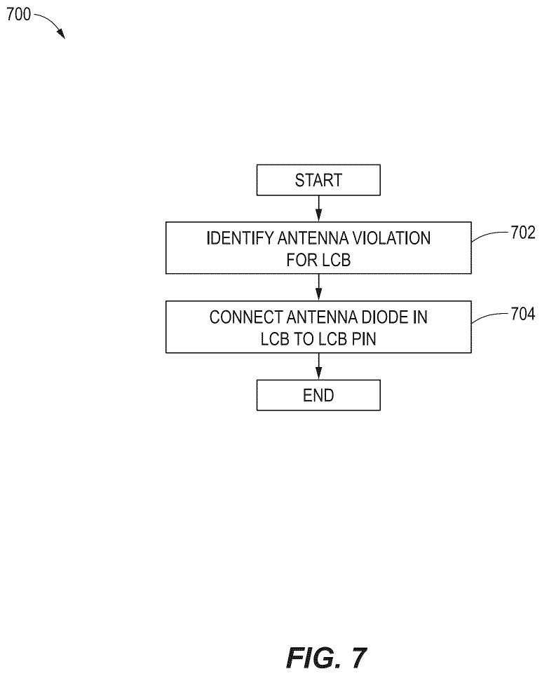

FIG. 7 is a flowchart 700 illustrating connecting an antenna diode to an LCB block, according to one embodiment. At block 702, a process (e.g., an automated tool or a human analyst) identifies an antenna violation for an LCB. As discussed above in relation to FIGS. 3-5, damage to gate oxide can result in an antenna violation for an MOS transistor (e.g., a MOSFET). An automated tool (e.g., used during manufacturing or operation for an IC) can identify this antenna violation. For example, the automated tool identify an antenna violation when the antenna ratio exceeds a value specified in a PDK. Similarly, a human analyst can identify an antenna violation.

At block 704, the process (e.g., the automated process or human technician) connects an antenna diode located in the LCB block to an LCB pin. For example, the LCB block can include an antenna diode inside the LCB block. This is illustrated, above, with regard to FIGS. 4-6. An automated tool (e.g., used during manufacturing) can connect a pin on this antenna diode to a pin on the LCB (e.g., a GCKN pin). For example, a router or other suitable tool can be used to short a pin on antenna diode to the LCB (e.g., the GCKN pin). This is discussed further, above, with regard to FIGS. 4-6.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages discussed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

While the foregoing is directed to embodiments of the present invention, other and further embodiments of the invention may be devised without departing from the basic scope thereof, and the scope thereof is determined by the claims that follow.

What is claimed is:

1. A method, comprising:
identifying an antenna violation relating to a first local clock buffer (LCB) for an integrated circuit (IC), wherein the IC comprises:
a first LCB block containing the first LCB and a first antenna diode disconnected from the first LCB; and
a second LCB block containing a second LCB and a second antenna diode, different from the first antenna diode, disconnected from the second LCB;
determining, based on the identifying the antenna violation, to connect the first antenna diode to the first LCB; and
connecting the first antenna diode to the first LCB in the first LCB block,
wherein the second antenna diode remains disconnected from the second LCB after the connecting.

2. The method of claim 1, wherein connecting the first antenna diode to the first LCB in the first LCB block comprises:
connecting a first pin associated with the first antenna diode and a second pin associated with the first LCB.

3. The method of claim 2, wherein the second pin comprises a general clock signal (GCKN) pin for the first LCB.

4. The method of claim 2, further comprising:
identifying a second antenna violation relating to the second LCB;
determining, based on the identifying the second antenna violation, to connect the second antenna diode to the second LCB; and
connecting the second antenna diode to the second LCB in the second LCB block.

5. The method of claim 4, wherein connecting the second antenna diode to the second LCB in the second LCB block comprises:
connecting a third pin associated with the second antenna diode and a fourth pin associated with the second LCB.

6. The method of claim 5, wherein the fourth pin comprises a general clock signal (GCKN) pin for the second LCB.

7. The method of claim 1, comprising:
using the second antenna diode to address a signal antenna issue for the IC, while the second antenna diode remains disconnected from the second LCB.

8. An integrated circuit (IC), comprising:
a first local clock buffer (LCB) block, the first LCB block comprising:
a first LCB for clocking the IC;
a first antenna diode; and
a connection between the first LCB and the first antenna diode,
wherein the connection between the first LCB and the first antenna diode is configured to alleviate an antenna violation for the IC relating to the first LCB; and
a second LCB block, the second LCB block comprising:
second LCB for clocking the IC; and
a second antenna diode, different from the first antenna diode,
wherein the second antenna diode is disconnected from the second LCB.

9. The IC of claim 8, wherein the connection between the first LCB and the first antenna diode comprises a connection between a first pin associated with the first antenna diode and a second pin associated with the first LCB.

10. The IC of claim 9, wherein the second pin comprises a general clock signal (GCKN) pin for the first LCB.

11. The IC of claim 9, further comprising:
a third LCB block, the third LCB block comprising:
a third LCB for clocking the IC;
a third antenna diode, different from the first and second antenna diodes; and
a second connection between the third LCB and the third antenna diode,
wherein the second connection between the third LCB and the third antenna diode is configured to alleviate a second antenna violation for the IC relating to the third LCB

12. The IC of claim 11, wherein the second connection between the third LCB and the third antenna diode comprises a connection between a third pin associated with the third antenna diode and a fourth pin associated with the third LCB.

13. The IC of claim 12, wherein the fourth pin comprises a general clock signal (GCKN) pin for the third LCB.

14. The IC of claim 8, wherein the second antenna diode is configured to address a signal antenna issue for the IC.

15. A method of manufacturing an integrated circuit (IC), comprising:
adding a first local clock buffer (LCB) block to the IC, the first LCB block containing a first LCB and a first antenna diode that is disconnected from the first LCB;
adding a second LCB block to the IC, the second LCB block containing a second LCB and a second antenna diode, different from the first antenna diode, that is disconnected from the second LCB;
identifying an antenna violation relating to the first LCB;
determining, based on the identifying the antenna violation, to connect the first antenna diode to the first LCB; and
connecting the first antenna diode to the first LCB in the first LCB block,
wherein the second antenna diode remains disconnected from the second LCB after the connecting.

16. The method of claim 15, wherein connecting the first antenna diode to the first LCB in the first LCB block comprises:
connecting a first pin associated with the first antenna diode and a second pin associated with the first LCB.

17. The method of claim 16, wherein the second pin comprises a general clock signal (GCKN) pin for the first LCB.

18. The method of claim 16, further comprising:
identifying a second antenna violation relating to the second LCB;
determining, based on the identifying the second antenna violation, to connect the second antenna diode to the second LCB; and
connecting the second antenna diode to the second LCB in the second LCB block.

19. The method of claim 18, wherein connecting the second antenna diode to the second LCB in the second LCB block comprises:
connecting a third pin associated with the second antenna diode and a fourth pin associated with the second LCB.

20. The method of claim 15, further comprising:
modifying the IC so that the second antenna diode is configured to address a signal antenna issue for the IC.
